(19) United States
(12) Patent Application Publication
(10) Pub. No.: US 2006/0218361 A1
(43) Pub. Date: Sep. 28, 2006

(54) Electronic storage device with rapid data availability

(75) Inventors: Richard M. Ehrlich, Satatoga, CA (US); Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electrical Industrial Co., Ltd., Osaka (JP)

(21) Appl. No.: 11/090,458

(22) Filed: Mar. 25, 2005

(51) Int. Cl. G06F 13/00

(52) U.S. Cl. 711/154

(57) ABSTRACT

An electronic storage device provides rapid data availability. The rapid data availability relates to sequences of reads and writes performed by the ESD responsive to critical events, such as power-up sequences or sequences of read and/or write operations. A sequence of reads is performed upon detecting a critical event. A record of reads to be performed is maintained in a reserved area of the disk. In the case of similar but different events, such as host power-up from an off state and host power-up from a hibernation state, different read and write sequences are performed for each scenario. Improvements to the sequence of reads and/or writes may be determined, thereby enabling the ESD to improve its response to critical events over time.

### CROSS REFERENCE TO RELATED APPLICATIONS

The present application is related to the following United States Patents and Patent Applications, which patents/applications are assigned to the owner of the present invention, and which patents/applications are incorporated by reference herein in their entirety: U.S. patent application Ser. No. 10/727,462, entitled “METHOD FOR PROVIDING CRITICAL DATA IN AN HDD AFTER CRITICAL EVENT”, filed on Dec. 4, 2003, Attorney Docket No. PANA-1123US1, currently pending.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to cache memory systems, and more particularly to enhancements to cache memory systems in power sensitive storage devices.

### BACKGROUND OF THE INVENTION

Computer devices with memory systems, such as desktop computers, laptop computers, notebook computers, PDAs, and other devices are becoming increasingly more common. As computer systems develop, thereby performing tasks faster and providing information more quickly, it becomes more desirable to make their corresponding memory systems operate faster and with higher reliability and efficiency. This includes providing data in a rapid manner during host computer power-up and other data retrieval scenarios.

FIG. 1 illustrates a method 100 for retrieving data from an electronic storage device (ESD) for a host device at power-on in accordance with the prior art. Method 100 begins with start step 105. Next, power is provided to both the ESD and host at step 110. After power-on, both the ESD and the host undergo initialization procedures associated with start up at step 120.

At step 130, the ESD informs the host device that the ESD is in a ready state and available to receive commands. Upon receiving the ESD ready signal, the host device may request data from the ESD at step 140. Typically, the host device first requests a boot sector to determine initialization procedures and data locations on the ESD media. The host drive may then determine the type of memory system the ESD is configured as, such as a FAT system. Next, the host device may request the FAT system files. From the FAT system files, the host device may request data clusters associated with start-up and initialization data. For each request, the host sends a data request as illustrated in step 140. The ESD processes the host request at step 150. Processing the host request may include spinning up the drive, loading the heads, seeking to the target track, and reading the requested information. The ESD response is then sent from the ESD to the host device in step 160. Typically, the host will spend a significant amount of time processing data received from the ESD before making additional requests, during with time the drive is idle, as shown in step 165. The ESD determines if more requests are received or queued at step 170. If more requests are to be processed, operation of method 100 continues to step 140. If no further requests are to be immediately performed, operation of method 100 ends at step 175. If no additional requests are made of the ESD over an extended period of time, it may even unload the heads and spin down. Thus, for each request for data by the host device, the ESD seeks to the location of the data, reads the data from the media into cache, and provides the data to the host device. The typical ESD data access process as illustrated in FIG. 1 requires considerable amounts of time to retrieve data at power-on, thereby generating an undesirable delay between receiving a data request from the host device and providing the requested data to the host device.

What is needed is a hard drive that operates using better data accessing methods for overcoming the foregoing disadvantages. One such disadvantage is that the ESD is idle at times while the host is busy, linearly adding to the ready delay in the example of power on time to ready.

### SUMMARY OF THE INVENTION

In one embodiment, an electronic storage device (ESD) of the present invention provides rapid data availability. The rapid data availability relates to sequences of reads and writes performed by the ESD, such as power-up sequences, for example. A sequence of reads and writes is performed upon detecting a critical event by the ESD. In one embodiment, a record of reads to be performed during power-up is maintained in a reserved area of the disk. In the case of similar but different power-up events, such as host power-up from an off state and host power-up from a hibernation state, different read and write sequences may be performed for each scenario. In one embodiment, an improved read sequence is determined. The improved read sequence enables improved reading of the critical data from the storage device in response to a subsequent occurrence of the critical event. In some embodiments, the ESD may be a hard disk drive (HDD). However, the present invention can also be applied to other ESDs, such as optical drives.

In one embodiment, a sequence (or ordering) in which to store the critical data associated with the detected event is determined. The sequence may be determined after the critical event has already occurred based upon an ESD log of the host operations requested from the previous occurrence. In one embodiment, an improved sequence may be computed after the original sequence was performed by the ESD and the optimization computations may be performed over an extended period of time. In this manner, sequences requiring more computational effort to determine may be used. In one embodiment, the sequence of operations recorded into the ESD log are read operations that do not overlap with observed write operations.

Once the sequence and critical data for a particular critical event are determined, the data may be written to the disk. In one embodiment, rather than re-allocating several target sectors of critical data somewhere to an area of the disk, a copy of the critical data may be written to a reserved area of the disk. The copy of the data may then be treated as a data-cache, to be maintained similarly as other drive caches. The log of matching host operations may be maintained on a reserved area of the disk or in flash memory to further speed access.

### BRIEF DESCRIPTION OF THE DRAWINGS Brief

FIG. 1 is an illustration of a conventional method for retrieving data from an ESD for a host device at power-on.

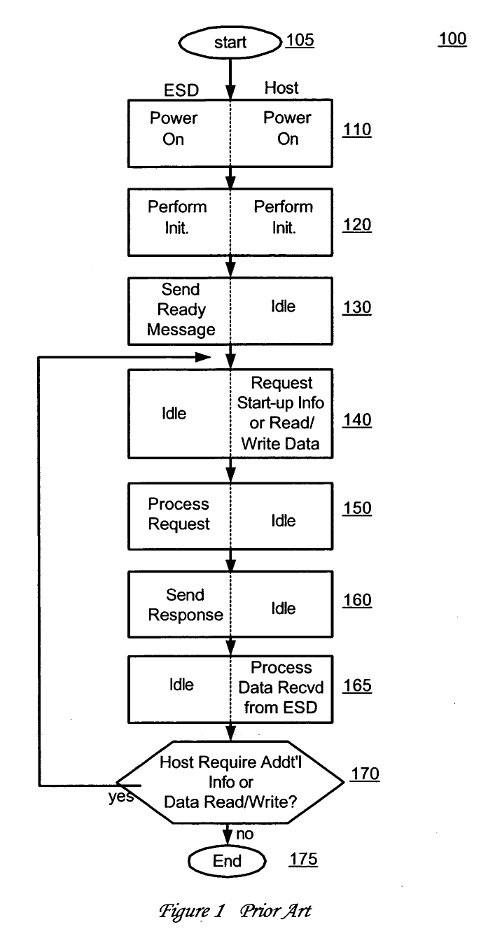

FIG. 2 is an illustration of an electronic storage device system in accordance with one embodiment of the present invention.

FIG. 3 is an illustration of a method for retrieving data from an ESD for a host device at the occurrence of an event in accordance with one embodiment of the present invention.

FIG. 4 is an illustration of a method for preparing for data retrieval from an ESD for a host device at the occurrence of an event in accordance with one embodiment of the present invention.

FIG. 5 is an illustration of a method for employing portions of a directed graph to control processing of host requests on an ESD in accordance with one embodiment of the present invention.

### DETAILED DESCRIPTION

In one embodiment, an electronic storage device (ESD) of the present invention provides rapid data availability. The rapid data availability relates to sequences of reads and writes performed by the ESD, such as power-up sequences, for example. A sequence of reads and writes is performed upon detecting a critical event by the ESD. As used herein, the term critical event is intended to be broadly construed to include any type of occurrence that precipitates a change in state of one or more of the ESD and any device operatively coupled with the ESD. In one embodiment, a record of reads (and writes) to be performed during power-up is maintained in a reserved area of the disk. In the case of similar but different events, such as host power-up from an off state and host power-up from a hibernation state, different read and write sequences may be performed for each scenario. In one embodiment, an improved read sequence is determined. The improved read sequence enables improved reading of the critical data from the storage device in response to a subsequent occurrence of the critical event. As used herein, the term critical data is intended to be broadly construed to include any type of data that may be associated with a critical event.

In one embodiment, a sequence (or ordering) in which to store the critical data associated with the detected event is determined. The sequence may be determined after the critical event has already occurred based upon an ESD log of the host operations requested from the previous occurrence. In one embodiment, an improved sequence may be computed after the sequence was performed by the ESD and which may occur over an extended period of time. In this manner, sequences requiring more computational effort to optimize may be used. Once the sequence and critical data for a particular critical event are determined, the data may be written to the disk. In one embodiment, rather than re-allocating several target sectors of critical data somewhere to an area of the disk, a copy of the critical data may be written to a reserved area of the disk. The copy of the data may then be treated as a data-cache, to be maintained similarly as other drive caches.

The present invention provides a system embodiment that enables critical data transfer from an ESD to a host device in a more rapid and more efficient manner. In one embodiment, the critical data is data associated with start-up and initialization of the host device and ESD. The start-up and initialization data may include FAT system data, boot sector data, fragments of the operating system, and other data. In other embodiments, the critical data is data for which the host device's need for the data can be predicted through different signals received, host device requests, or the occurrence of some other event. One such different signal is the running of a particular application from the ESD. While the invention is illustrated generally with reference to an example of devices responding to power-up events as the critical event, the present invention is not limited to such events, and in some embodiments, techniques according to the invention may be implemented in devices responding to a wide variety of events.

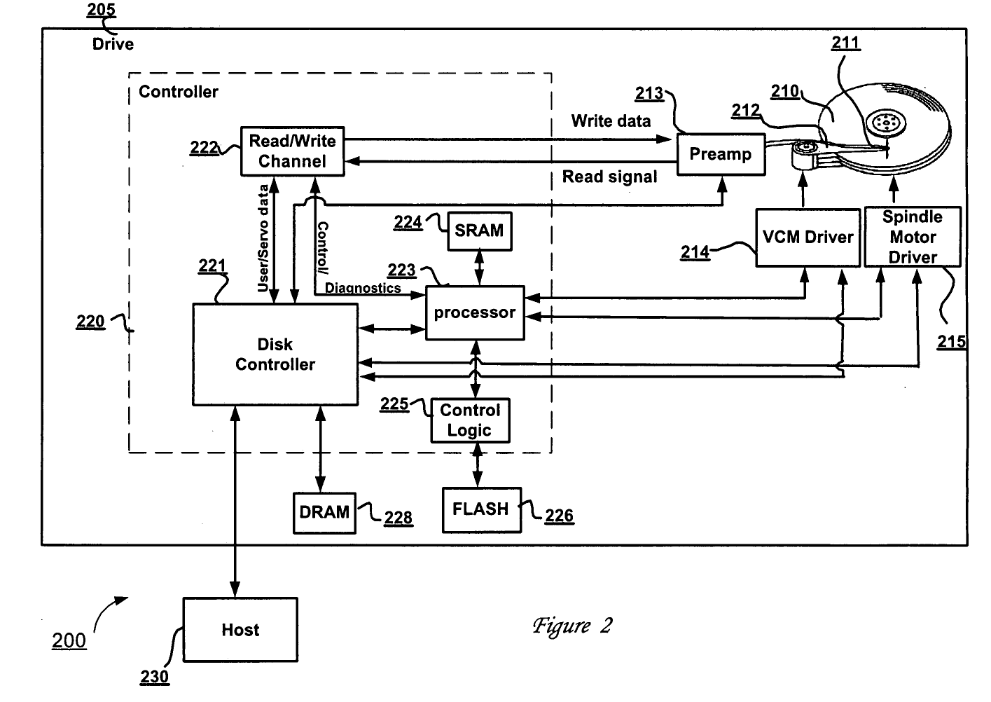

FIG. 2 illustrates an ESD system 200 in accordance with one embodiment of the present invention. ESD system 200 includes an ESD 205 and a host 230. The ESD 205 is comprised of controller circuitry 220, media 210, write and read heads 211, actuator 212, preamp 213, VCM driver 214, spindle motor driver 215, DRAM 228, and FLASH 226. Controller circuitry 220 includes disk controller 221, read/write channel 222, processor 223, SRAM 224 connected to processor 223, and control logic 225 connected to processor 223 and FLASH 226. A host device 230 is connectively coupled to drive 205. In operation, the disk controller 221 treats DRAM 228 as an intermediate buffer and cache between the media 210 and the host 230 for read and write operations. The processor 223 handles access to FLASH 226 as well as initiating access to media 210 through the disk controller 221, Read/Write Channel 222, Preamp 213, and write and read heads 211. In one alternative embodiment, the FLASH can also be accessed from the disk controller 221. In this case, a line (not shown in FIG. 2) connects the Control Logic 225 with disk controller 221.

Rapid Availability of Critical Data

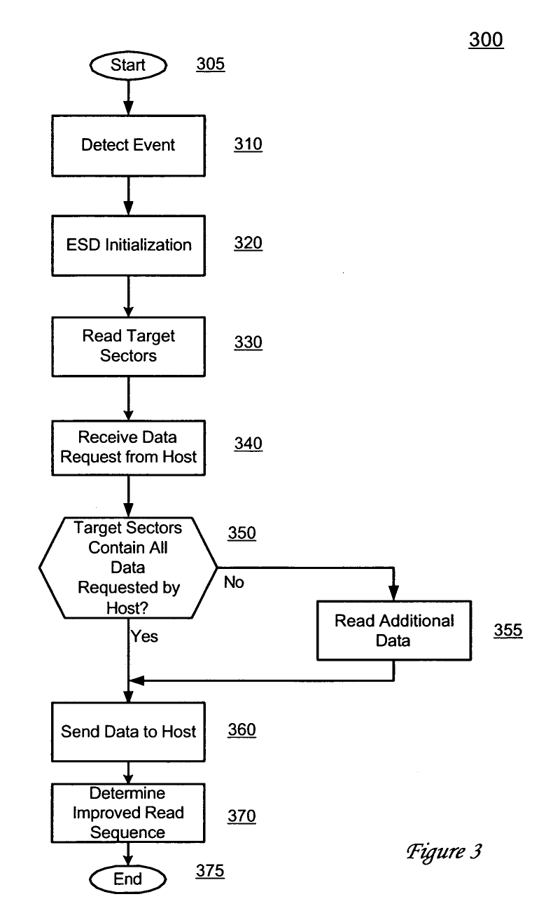

FIG. 3 illustrates a method 300 for retrieving data at the detection of a critical event by an ESD. Method 300 begins with start step 305. Next, a critical event is detected at step 310. The critical event indicates that the host device is likely to request critical data in the near future. In one embodiment, the critical event includes a power-up by the host. Next, ESD initialization is performed at step 320. ESD initialization may include spinning up the ESD media, loading the heads, and other tasks performed by the ESD when the drive is not in the ready-state. In another embodiment, the initialization may include performing operations associated with a host power-up sequence. In one embodiment, the ESD is initialized when it is able to seek to tracks and read data. Optionally, if the ESD is ready to perform a seek when the critical event is detected, fewer or no initialization steps may be performed at step 320.

Once the ESD is initialized, it proceeds to read critical data from target sectors at step 330. The target sectors are sectors determined to have data that is very likely to be requested by a host device based on the critical event. In an embodiment where the host computer is booting up, the target sectors may include a boot sector, FAT data or information, and other data needed by the host device upon start-up. Once read, the data from the target sectors may be loaded into cache memory located within the ESD. Next, the ESD receives a request for critical data from the host at step 340. In decisional step 350 the ESD determines whether the data read from the target sectors into the cache in step 330 includes all the critical data requested by the host at step 340. If the data does not meet the host's needs, then additional (or different) data may be read in step 355. Once data matching the host's request is obtained, the critical data is sent to the host in response to the received request at step 360. It is possible that data that has already been read in may be sent to the host at the same time that the drive reads additional data. An improved read sequence is determined at step 370. The improved read sequence enables improved reading of the critical data from the storage device in response to a subsequent occurrence of the critical event. Accordingly, execution of step 370 may enable certain ESD embodiments to become “smarter” with each critical event occurrence. In other words, the ESD embodiment will be more likely to provide the correct critical data requested by the host device at a critical event after the requested data from previous critical events is compared. Operation of method 300 then ends at step 375.

In one embodiment, after initialization of the ESD at step 320, information regarding the location of the target sectors is retrieved at step 330. In one embodiment, the information about the target sectors locations is stored on a reserved portion of the disk of the ESD. Storing the target sector location on the ESD disk allows for storage of much information—potentially more information than may be possible if the information were stored on other memory such as the ESD Flash. Additionally, since the ESD typically undergoes initialization at step 320, it does not require much additional power or time to retrieve the location information. Rather, it would likely require one additional seek/read operation to the power-up sequence, which will likely need to access the disk for SMART or for some other reason at initialization. Another advantage of storing the target sector information on the ESD disk as opposed to other ESD memory, such as FLASH, is that FLASH would not need to be reprogrammed as often. This would protect against the danger of losing other data stored in flash.

The target sector read operation at step 330 is in response to the detected critical event at step 310. The critical event can be one of many types of events. One type of critical event may relate to the initiation of an ESD and host computer power-up sequence. Many computers support at least two types of power-up sequences: a “cold-boot” power-up from an off state and a “wake-up” power-up from a hibernation state. In this case, different target sectors may be associated with different critical events, such as a “cold-boot” power-up and a “wake-up” power-up.

In an embodiment where the critical event is a host power-up, the ESD may receive host data from the host instructing the ESD what type of power-up sequence should be performed at the next power-up event. For example, the host data may include instructions to the ESD that the host is entering a hibernation state, a power-off state or other state. A host hibernation flag or other flag(s) in the ESD may be used to indicate the determined state of the host. From the hibernation flag, the ESD may determine what target sectors to access, and what type of corresponding power-up sequence to execute, upon the next host power-up.

In another embodiment, the ESD may determine which type of power-up to perform based on observed host activity before shut-down of the ESD and host. In one embodiment, if the ESD is instructed to go into a standby or sleep mode by the host, then the ESD will indicate with the hibernation flag that the host is in hibernate or sleep mode. In another embodiment, if the ESD observes the host performing a large write operation involving a sequential group of sectors, the ESD may indicate with the hibernation flag that the host is about to go into a hibernation state. Upon the next ESD power-up, the drive will detect the state of the host from the hibernation flag and will seek to the target sector associated with a “post-hibernation power-up” sequence, or other appropriate sequence of operations. In one embodiment, the large sequential write done by the host to record memory and peripheral settings in preparation for hibernate are not moved to a reserved area because the data is already stored in an optimal manner near the reserved area of the ESD.

Thus, in accordance with one embodiment of the present invention, the ESD may attempt to determine which of a plurality of sequences to perform at the occurrence of a critical event, including host power-up events. Different groups of target sectors may be read for different critical events. It should be understood that the term, “group of target sectors”, includes the possibility of a single target sector, a number of adjacent sectors, several isolated individual sectors, several different sets of consecutive sectors, or any combination of the above. In one embodiment, the sequence initiated may be determined to be wrong after the sequence has already been started. This may occur, for example, if the host makes a request indicating it is performing a cold-boot while the ESD is executing a sequence of read operations in anticipation for a post-hibernation boot-up. In this case, the ESD may immediately cease the current sequence and initiate a corrected sequence.

At step 330, the ESD reads critical data from a target sector. The ESD may determine what the critical data is and where target sectors shall be located in numerous ways. In any case, the ESD will exhibit faster performance by providing previously retrieved critical data to the host device without spending time to retrieve the critical data from the media after such data is requested by the host 230. Even if the ESD has not yet finished retrieving the critical data at the time that the host requests it, having already started the data-retrieval operation in advance of receiving a request for the data will shorten the time between the request and delivery of the data.

In one embodiment, the critical data are determined to be the same critical data called after a similar previous critical event was detected. For instance, in the case of ESD power-on, the critical data read at step 330 may be the same critical data read for the previous power-on of the ESD and host device. In another embodiment, the critical data may be determined to be the most often requested data after a number of previous critical events were detected. The number of previous critical events may be any number, such as the last ten, twenty, or hundred events. The number may also be a running total of events. In this embodiment, the ESD may get “smarter” with each boot-up, and be more likely to provide the correct critical data requested by the host device at power-on after the requested data from past power-ones is compared.

In another embodiment, the critical data or target sector may be data or a sector designated by a user of the ESD, manufacturer of the host device, or some other party. Thus, in one embodiment, the ESD could be configured to receive vendor unique commands to the ESD indicating what target sectors or critical data should be read to prepare for an upcoming request.

The concept of determining what critical data and target sectors to store and retrieve are in contrast to methods performed by the prior art. In particular, the present invention stores and caches data that has typically not been accessed recently. Unlike the present invention, most cache systems save the most recently used or requested data on the assumption that what was most recently written or read is more likely to be accessed again. Thus, in the present invention, and most particularly with regards to managing critical data for the next power-up event, the data requested is often not only not the most recently requested, but data that would be deleted by most other cache systems over time.

Target Sector Storage

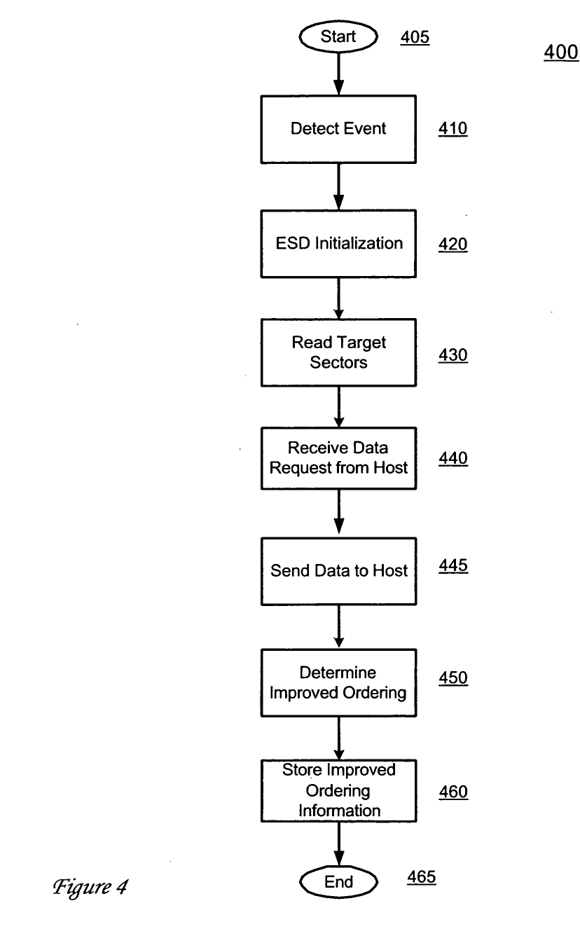

The target sectors containing the critical data can be written to the disk of the ESD in several ways in accordance with the present invention. In one embodiment, the critical data is written to the disk based on data requests during previous sequences. Thus, wherein the critical data is associated with data requested during power-up sequences, the critical data is written to the disk based on data requests during previous power-up sequences. Method 400 of FIG. 4 illustrates a method for ordering the storage of critical data on the disk of an ESD in accordance with one embodiment of the present invention.

Method 400 begins with start step 405. Steps 410 through 440 of method 400 are similar to steps 310-340 of method 300. At step 410, an event is detected by the ESD. In one embodiment, the event my may be an indication that the host is initiating a boot-up. At step 420, the ESD undergoes initialization. The ESD then reads target sectors at step 430. Next, a data request is received from a host at step 440. The ESD sends the data to the host at step 445.

At step 450, the ESD may perform computations to determine an improved ordering of data reads, to reduce the time that it takes to read the target sectors. In some embodiments, the drive may determine the data to be read should be copied to a system or reserved area on the media so that the data can be accessed sequentially because sequential reads are usually the fastest way to read large amounts of data. Since the computations at step 450 are performed after the ESD has received the sequence of host requests, such as host power-up requests, the ESD may use more powerful and effective algorithms than it typically uses for write-caching. The ESD may also perform optimizations with the benefit of knowing the entire sequence of host commands. In one embodiment, the ESD performs the computations after receiving the sequence of host requests over an extended period of time. In this manner, the ESD may expend more computational effort than it could normally afford to.

In one embodiment, a rotational-optimization algorithm may be used to improve the initial data reads by the ESD at power-up. In systems of the prior art, a parallel ATA drive may not queue reads. Upon receiving a read command in a parallel ATA drive, the data must be returned before the operation is complete. In serial ATA drives and SCSI drives, multiple read requests may be reordered in their execution. In most electronic storage devices, however, write commands may be reordered.

Unlike systems of the prior art, read operations in an ESD of the present invention can be reordered regardless of the type of drive being used. This is made possible by predicting what read operations will be requested by the host and performing them before the sequence of requests is completely received. By performing the requests before they are actually received, the ESD of the present invention may perform the reads in any order. In particular, the ESD may perform read operations utilizing rotational optimization before the host read requests are received by the ESD.

In addition to typical rotational-optimization algorithms, other algorithms that require more computational power may be used to organize read/write sequences as well. In one embodiment, the ESD may anticipate doing a series of read and write operations during a power-up sequence. In this case, the ESD may attempt to re-order a combined read/write stream and schedule the writes for times after which it expects to have been given the actual data and location. As an example, previous sequence records may indicate that scheduling certain read operations after specific writes in a sequence is optimal because of idle time available to the ESD. Had the ESD done the reads earlier, the total time to complete a sequence would increase.

Returning to method 400, at step 460, the ESD stores information about the improved ordering of read commands to be performed upon the next reception of a similar critical event. This information may be stored in flash memory or on the media in a system or reserved area. The critical data may be reordered in this step as discussed above. Operation of method 400 then ends at step 465.

The target sectors accessed at step 430 of method 400 contain the critical data that the ESD accesses in response to the detection of a critical event. The target sectors can be written to the media in several ways in accordance with the present invention.

Target sector reallocation techniques used to address replacing defective sectors are known. For example, U.S. Pat. No. 5,235,585, entitled “Reassigning defective sectors on a disk” and U.S. Pat. No. 6,189,110, entitled “Disk device and data reassignment method,” which are hereby incorporated by reference in their entirety, each discloses a mechanism for replacing a defective sector with a spare sector.

In one embodiment, rather than reallocating the critical data on the disk of the ESD, a copy is made of the critical data to be read upon the detection of a critical event. The copy of the critical data is then written to the media of the ESD. The critical data copy may be stored in a sequential region located within the system or reserved cylinders of the ESD disk. Storing the critical data copy is analogous to maintaining a large data-cache. The critical data copy would be maintained to remain coherent with the original data as is the case for a typical cache. Maintaining the critical data copy as a cache in the system cylinder takes up space in the disk system cylinders that could otherwise be used for other purposes and additional cache-coherency code. However, maintaining a critical data copy in this manner provides for fast sequential reading of critical data and does not add significant additional complexity to systems that may utilize an LBA to PBA mapping algorithm. In one embodiment, the critical data copy stored on the disk includes critical data requested by a host computer during a power-up. In this case, the critical data copy includes data that is requested at power-up by the host computer and generally does not change very often. Thus, although the critical data copy of the requested power-up data by is maintained as a cache, the data copy will not require updating very often.

In one embodiment, the order of the copy of the data could be determined by a log containing information regarding past requests received by the hard drive for critical data. Based on the log contents, the hard drive may arrange the critical data in the copy such that data would be written to sequential sectors in the general order the log indicates they were requested. The sequential order could be determined in several ways, including the order the critical data sectors were last read from or the order the critical data sectors have been read most frequently.

In accordance with the present invention, the critical data sector copy can be written to reserved areas that further enhance the speed and reliability of critical data access operations. In one embodiment, the critical data can be written to reserved tracks having an RRO that is smaller than the typically accepted RRO. The smaller than typically accepted RRO could be achieved though more careful servowriting or extensive use of RRO-reduction techniques on final wedges, which processes are generally known in the art. Methods for using RRO-reduction technologies during a self-servowriting process are disclosed in U.S. Pat. No. 6,631,046, entitled, “Servo Track Writing Using Extended Copying With Head Offset,” which is hereby incorporated by reference in its entirety. Methods for using RRO-reduction technologies in general (either during a self-servowriting process, or after servowriting, to reduce the RRO of the servowritten wedge pattern) are disclosed in U.S. Pat. No. 6,069,764, entitled “Compensation For Repeatable Run-Out Error,” which is hereby incorporated by reference in its entirety. As would be apparent to one of ordinary skill in the art, the techniques disclosed in these patents can provide reduced RRO at the cost of longer processing-time during the drive manufacturing process. Methods for enhancing the speed and reliability of critical data access operations are also disclosed in U.S. patent applications entitled, “Methods For Self-Servowriting With Multiple Passes Per Servowriting Step,” patent application Ser. No. 10/818,185, “Methods For Selective Multi-Pass Servowriting And Self Servowriting,” patent application Ser. No. 10/818,472, “Methods For Self-Servowriting Using Write-Current Variation,” patent application Ser. No. 10/818,174, “Methods For Variable Multi-Pass Servowriting And Self Servowriting,” patent application Ser. No. 10/818,177, “Methods Using Extended Servo Patterns With Multi-Pass Servowriting And Self Servowriting,” patent application Ser. No. 10/818,175, and “Methods Using Extended Servo Patterns With Variable Multi-Pass Servowriting And Self Servowriting,” patent application Ser. No. 10/818,445, and “Methods For Conditional Servowriting,” patent application Ser. No. 10/819,089, each of which is hereby incorporated by reference in its entirety.

In another embodiment, the critical data copy can be written to tracks having a higher than normal inter-track spacing. For example, the tracks surrounding the track containing the critical data can be erased, kept isolated, or the track spacing between the critical data track and surrounding tracks can be increased. The use of isolated tracks can enhance the speed of reading by allowing very rapid seeks to the target tracks, with relatively loose settle-criteria, because there would not be much signal interference from adjacent data-tracks. Maintaining critical data on every other track, for example, allows for easier writing and off-track reading of the critical data. However, the portion of the disk for which only every other track is utilized will be reduced to one half of its potential capacity. In one embodiment of the present invention, the hard drive can be configured through programming to utilize a customized quantity of the hard drive media for isolated critical data storage. Thus, a host device could indicate how much space should be reserved for storing critical data on isolated tracks. It is understood that the track spacing, especially for a self servo written drive, can be increased in certain regions of the media and not at others so as not to suffer the 2:1 space penalty of skipping every other data track.

In yet another embodiment, the critical data copy could be written to a track in a slower than typical manner. Typically, hard drives write data to data tracks as fast as possible while still maintaining some minimum servo accuracy threshold. Thus, slower than typical data track writing means writing at a speed that is less than the optimal writing speed for the head and media combination. Slower track writing can reduce the mis-placement of the written data to within a smaller range than that normally considered acceptable. As a result, the data may be read easier at faster speeds. For example, the drive could seek to the target tracks on which the data is to be written using more conservative settle-limits, so that the resulting post-seek TMR (Track Mis-Registration) is more nearly equal to the steady-state on track TMR. The drive could also use lower offtrack limits (i.e., measured position at which writes are halted to prevent data being written too far offtrack). Although this might result in slower writing due to the need for multiple attempts (because some writes are stopped when the R/W head exceeds the reduced offtrack error-limit), the resulting data will be written very close to the center of its designated track. Lower data-frequencies could also be used, to reduce inter-bit interference. In another embodiment, a combination of low RRO tracks, isolated tracks, and slow track writing lower frequency data and tighter offtrack limits can be used to make it easier to later quickly read critical data.

In one embodiment, an ESD of the present invention provides rapid data availability. The rapid data availability relates to sequences of reads and writes performed by the ESD, including power-up sequences. The sequence of reads and writes is performed upon detecting a critical event by the ESD. In one embodiment, a record of reads to be performed during power-up is maintained in a reserved area of the disk. In the case of similar but different events, such as host power-up from an off state and host power-up from a hibernation state, different read and write sequences are performed for each scenario. The order in which to store the critical data associated with the detected event is determined by an algorithm. The algorithm may be implemented after the critical event has already occurred and the ESD has a log of the host operations requested from the previous occurrence. Once the sequence and critical data for a particular critical event is determined, the data may be written to the disk. In one embodiment, rather than re-allocating several target sectors of critical data somewhere to an area of the disk, a copy of the critical data may be written to a reserved area of the disk. The copy of the data may then be treated as a data-cache, to be maintained similarly as other drive cache.

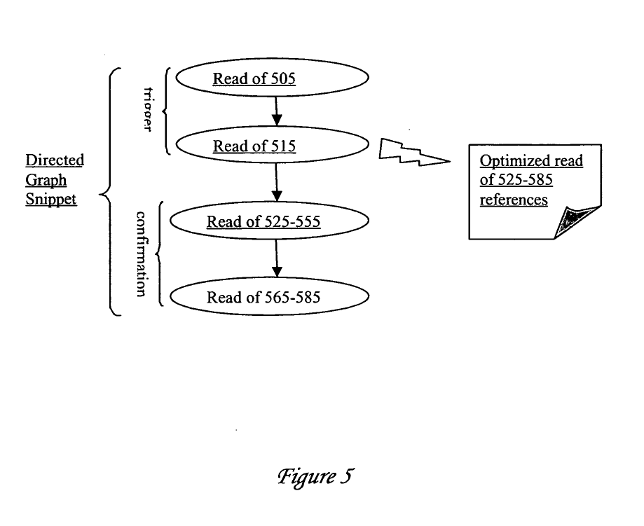

The following example embodiment illustrated by FIG. 5 shows an embodiment employing portions of a directed graph to control processing of host requests on an ESD. In one embodiment, the drive logs R/W, addresses, and length information as host requests arrive. These are stored as pieces of directed graphs (hereinafter “snippets”). A process in the ESD is continuously looking through these directed graphs trying to latch on to a path. This could happen, for example, when the directory entry of an application is read. The reaction is to follow the directed graph and execute the reads and confirm the writes, especially if the “main” process of the ESD is idle. In one embodiment, these snippets of graphs can “age” (throwing away little-used snippits, in favor of newly encountered ones) so that the overall memory used in the recordings can be finite. In the background, these snippets can also have their read portions reordered. In such a case, the original ordering of host requests can be kept separately, to assist in recognizing a match between an ongoing sequence and a previously encountered one.

Now with reference to FIG. 5, a first reference to an application is stored on a storage device. The sequence starts with a host reference to (i.e., a read of) a directory entry 505. Then, in this example, the retrieval pointers 515 are referenced to locate the pieces of the application. Then some of the parts of the application 525-555 are read. Then additional libraries 565-585 referenced by the application are read. Enough of the application is now in memory that it can begin to execute.

As the host makes the initial reads to directory entry 505, the ESD starts to follow the directed graph snippet (which was created after a previous sequence of similar data requests from the host). Once the retrieval pointers 515 are read by the host, this becomes a critical event (i.e., enough of a match with the previous sequence to justify speculative reading of the rest of the previously-requested data) and causes the remaining blocks that comprise 525-585 to be read in an optimized order. As the ESD continues to traverse the directed graph as the host references 525-585, the blocks being read as a result of the critical event proceed concurrently and asynchronously.

It should be clear that the process that tracks traversals through the directed graphs might be following multiple graphs at the same time. This should be intuitive since, as one application is loading, other work can be performed concurrently. A graph snippet is followed until it confirms at the end of the snippet or if it times out. Writes, as the ESD follows a graph snippet, do not contribute to the traversal; and can be ignored. In another embodiment the writes serve as confirmation nodes in the directed graphs but the address information (LBA address) is ignored.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, various embodiments of the present invention may be conveniently implemented using a conventional general purpose or a specialized digital computer(s) or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of general purpose or application specific integrated circuits and/or by interconnecting an appropriate network of conventional component circuits, as will be readily apparent to those skilled in the art.

Various embodiments of the present invention include a computer program product which is a storage medium (media) having instructions stored thereon/in which can be used to program a general purpose or specialized computing processor/device to perform any of the features and processes presented herein. The storage medium can include, but is not limited to, one or more of the following: any type of physical media including floppy disks, optical discs, DVD, CD-ROMs, microdrives, holographic storage, magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Various embodiments include a computer program product that can be transmitted over one or more public and/or private networks wherein the transmission includes instructions which can be used to program a computing device to perform any of the features presented herein.

Stored on any one or more of the computer readable medium (media), the present invention includes software for controlling both the hardware of general purpose/specialized computer(s) or processor(s), and for enabling the computer(s) or microprocessor(s) to interact with a human user or other mechanism utilizing the results of the present invention. Such software may include, but is not limited to, device drivers, operating systems, execution environments/containers, user interfaces and applications.

Included in the programming (software) of the general/specialized computer or microprocessor are software modules for implementing the teachings of the present invention, including, but not limited to, an improved electronic storage device with rapid data.

1. A method for reading data from an electronic storage device, the method comprising:
detecting an occurrence of a critical event;
reading critical data associated with the critical event from a target group of sectors of an electronic media of the electronic storage device, wherein the critical data is read according to a first read sequence;
receiving a data request;
sending the critical data responsive to the data request; and
determining an improved read sequence, the improved read sequence enabling improved reading of the critical data from the storage device in response to a subsequent occurrence of the critical event.

2. The method of claim 1, wherein the detected critical event is one of a plurality of recognizable critical events and a target group of sectors is associated with each of the plurality of detected critical events.

3. The method of claim 2 wherein the critical event is a power-on of a host.

4. The method of claim 3 wherein the power-on is a host cold boot, the target group of sectors including data requested during previous host cold boots.

5. The method of claim 3 wherein the power-on is a host post-hibernation boot, the target group of sectors including data requested during previous host post-hibernation boots.

6. The method of claim 1 wherein the critical data is a copy of original data located in another location on the disk drive, the critical data maintained to be coherent with the original data.

7. The method of claim 1 further comprising:
storing host requests as at least a portion of at least one directed graph; and
executing at least a portion of the host requests by traversing the at least a portion of the at least one directed graph responsive to detecting the critical event.

8. A method for writing data on an electronic storage device, comprising:
detecting the occurrence of a critical event;
receiving a plurality of requests for critical data, each request requiring access to a portion of the critical data;
determining a sequence for the critical data; and
writing the critical data to the disk drive of the electronic storage device in the determined sequence.

9. The method of claim 8 wherein determining a sequence includes:
determining a sequence when the electronic storage device is not executing a command.

10. The method of claim 8 wherein determining a sequence includes:
determining an order for the critical data based upon a rotational-optimization algorithm.

11. The method of claim 8 wherein writing the data includes:
generating a copy of the critical data, the copy residing in the sequence determined; and
writing the copy of the data to the disk drive of the electronic storage device, the copy of the data maintained to be coherent with the critical data.

12. The method of claim 8, wherein the detected critical event is one of a plurality of recognizable critical events and a target sector is associated with each of the plurality of detected critical events.

13. The method of claim 12 wherein the critical event is a power-on of the host.

14. The method of claim 12 wherein the power-on is a host cold boot, the target sector including data requested during previous host cold boots.

15. The method of claim 12 wherein the power-on is a host post-hibernation boot, the target sector including data requested during previous host post-hibernation boots.

16. A method for determining a state of a host computer by an electronic storage device, comprising:
detecting a host computer operation by the electronic storage device;
determining that the host computer is in a particular state;
setting the value of a flag at the electronic storage device; and
detecting an occurrence of a critical event by the electronic storage device;
performing a selected one of a plurality of sequences of operations by the electronic storage device, the selected sequence associated with the particular state.

17. The method of claim 16 further comprising:
determining an improved ordering of operations for the selected sequence, the improved ordering of operations enabling improved reading of the critical data from the electronic storage device in response to a subsequent occurrence of the critical event.

18. The method of claim 16 wherein detecting an operation includes:
receiving a signal to go into hibernation mode, the signal received by the electronic storage device, the particular state being a hibernation state, the selected sequence being a post-hibernation power-up sequence.

19. The method of claim 16 wherein detecting an operation includes:
receiving an signal to go into shut-down mode, the signal received by the electronic storage device, the particular state being a shut-down state, the selected sequence being a post-shutdown power-up sequence.

20. The method of claim 16 wherein detecting an operation includes:
receiving a write command sent to the electronic storage device from the host, the write command instructing the electronic storage device to write to a sequential group of sectors shortly before performing power-down of the electronic storage device, the particular state being a shut-down state, the selected sequence being a post-shutdown power-up sequence.
